(19) United States
(12) Patent Application Publication
(10) Pub. No.: US 2006/0175799 A1
(43) Pub. Date: Aug. 10, 2006

(54) Utility trailer with elevating platform

(75) Inventor: Robert Heynssens, Gladstone, MI (US)

Correspondence Address: QUARLES & BRADY LLP, 411 E. WISCONSIN AVENUE, SUITE 2040, MILWAUKEE, WI, 53202-4497, US

(73) Assignee: Power Platforms, Inc.

(21) Appl. No.: 11/053,007

(22) Filed: Feb. 8, 2005

(51) Int. Cl. B60P 1/02

(52) U.S. Cl. 280/414.5; 280/656

(57) ABSTRACT

A trailer has a load carrying bed to which a carriage frame and a coupling are slideably attached to opposite sides. Actuators are provided to move the bed with respect to both the carriage frame and the coupling. At least one wheel is attached to the carriage frame to support the utility trailer on the ground. When the coupling is connected to a hitch on a motor vehicle, operating the actuators lowers the bed against the ground to facilitate loading and unloading and raises the bed to enable the trailer to travel.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to on-road trailers for towing behind a motor vehicle, and more particularly to utility trailers that have a single wheel.

2. Description of the Related Art

Utility trailers are commonly towed behind motor vehicles, such as pick-up trucks and automobiles, to transport relatively various kinds of loads. Most utility trailer trailers are designed for a specific application: for example, boat trailers, camping trailers, trailers with pods, and flat bed trailers. It is also known to utilize single-wheel utility trailer trailers for relatively light weight loads to reduce the cost of the device. The single wheel generally is displaced rearward of the trailer kingpin by which the trailer is coupled to the motor vehicle and that positioning enables the wheel to follow turns. To allow a motor vehicle with a single-wheel trailer to be driven backwards easily, it is common to use a double hitch which provides a non-articulated coupling.

A typical single wheel utility trailer has a fixed rectangular bed and removable side walls. The single wheel is fixedly mounted beneath a longitudinal frame of the bed and cannot caster. Thus the wheel tends to skid laterally during a turn. Alternatively, a caster mounted wheel, as described in U.S. Pat. No. 4,645,230, can be used to follow the towing vehicle through turns.

Although the bed of a utility trailer usually is only a foot or two above the ground the load being carried must be lifted onto and off of the trailer. One frequent use of a utility trailer is to transport a garden tractor, snowmobile or other article with wheels. Such transport requires the attachment of ramps to enable the article to be driven on and off the trailer. The ramps then must be carried on the utility trailer during the transport and stored when not required. Therefore, it is desirable to facilitate the loading and unloading of utility trailers, especially in a manner that does not require ramps.

### SUMMARY OF THE INVENTION

A utility trailer for towing by a motor vehicle comprises a bed with a platform for supporting a load that is carried by the utility trailer while traveling on a road. A coupling is moveably connected to the platform for mating with a hitch on the motor vehicle and a carriage frame also is moveably connected to the platform. At least one wheel is attached to the carriage frame to support the utility trailer on the road. An actuator assembly moves the platform with respect to the coupling and the carriage frame to raise and lower the platform with respect to the road.

The actuator assembly enables the platform to be lowered against the road for loading and unloading the trailer. This allows articles with wheels, such as garden tractors and snowmobiles to be driven on and off the trailer platform. The actuator assembly raises the platform to enable the trailer to travel on the road when towed behind a motor vehicle.

In one embodiment of the trailer, the carriage frame is slideably attached to the rear of the trailer platform and a first linear actuator produces motion there between. The coupling is similarly slideably attached to the front of the platform and a second linear actuator produces motion between those components. Operating the second linear actuator, while the platform is on the road, adjusts the height of the coupling to mate with a hitch on a motor vehicle. After that connection has been made, operating both linear actuators in unison raises the platform off the rod.

A two wheeled trailer incorporating this novel platform elevating mechanism also is described.

### BRIEF DESCRIPTION OF THE DRAWINGS

FIG. 1 is a top view of a single-wheeled utility trailer according to the present invention;

FIG. 2 is a side elevational view of the utility trailer with its bed lowered to the ground for loading and unloading;

FIG. 3 is a rear elevational view of the utility trailer in FIG. 2;

FIG. 4 is a front elevational view of the utility trailer in FIG. 2;

FIG. 5 illustrates the hitch by which the utility trailer is attached to a motor vehicle;

FIG. 6 depicts the utility trailer with its bed raised from the ground for travel; and

FIG. 7 is a top view of a two-wheeled utility trailer according to the present invention.

### DETAILED DESCRIPTION OF THE INVENTION

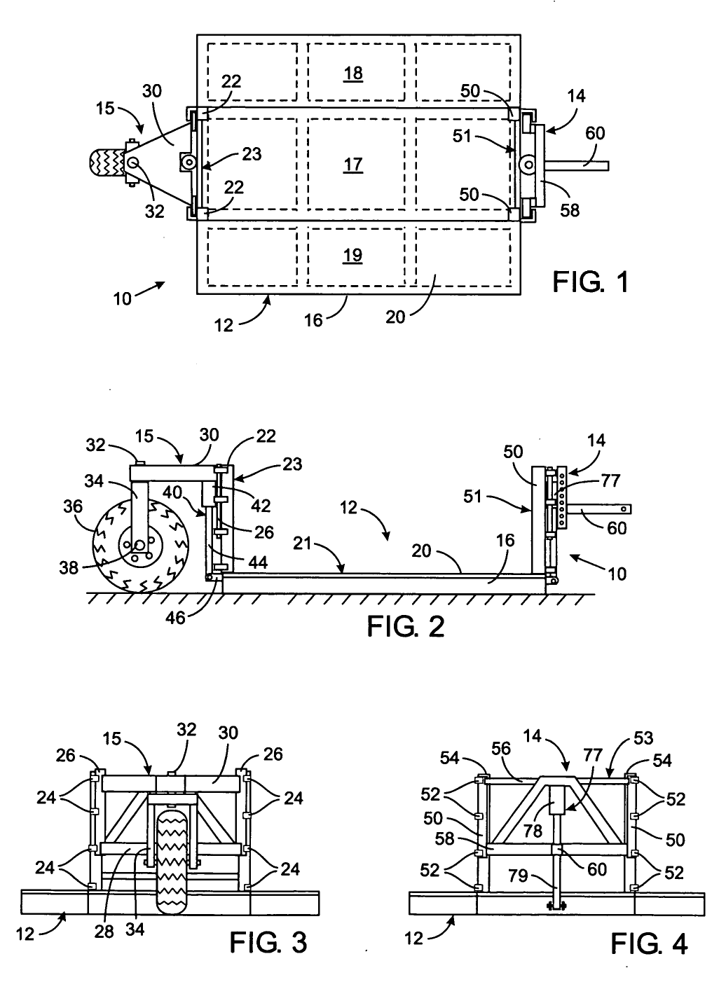

With initial reference to FIGS. 1 and 2, a utility trailer 10 for towing behind an automobile or a small truck, such as a pick-up truck, has a bed 12 having a front side connected to a vehicle coupling 14 and a rear side connected to a carriage frame 15. The bed 12 comprises a rectangular under frame 16 with a number of cross members to provide internal support. For example, the under frame may be fabricated of square, tubular metal stock. A rectangular plate 20 of steel or similar material is attached to the upper side of the under frame 16 thereby providing a platform 21 on which to place a load for carrying by the utility trailer. In one embodiment, the platform 21 is formed by a center section 17, to which the vehicle coupling 14 and the carriage frame 15 are connected, and a pair of side sections 18 and 19 removably fastened to opposite lateral sides of the center section. This embodiment enables the width of the utility trailer 10 to be adjusted to fit the load being carried.

The rear side of the bed 12 has a pair of vertical posts 22 extending upward from the under frame 16, spaced apart and centered about the middle of that rear side. The rear posts 22 form a first frame 23. One or more cross members may extend between the two vertical rear posts 22 for strength. The carriage frame 15 is coupled to these rear posts in a manner that allows vertical motion there between. With additional reference to FIG. 3, a four of L-shaped guides 24 are attached to the outer lateral side of each rear post 22 and bend around the rear of the post. Space is provided between the read surface of each vertical rear post 22 and guides 24 to receive vertical legs 26 of the carriage frame 15 so that those legs can slide up and down along the rear posts 22. A lower horizontal member 28 is welded between the two carriage frame legs 26. A triangular wheel mount 30 projects outward from the top sections of each carriage frame leg 26 and is welded thereto. The wheel mount 30 has an aperture adjacent its remote apex. An inverted U-shaped wheel bracket 34 has a pivot shaft 32 extending upward through the aperture in the wheel mount 30 in a manner that allows the wheel bracket 34 to rotate horizontally. A wheel 36 is mounted on an axel 38 that extends through bearings at the remote ends of each leg of the wheel bracket 34. The term “wheel” is generically used herein to include wheels with different types of tires and other wheels that allow an object to roll on a roadway.

A first actuator 40, such as a motor driven, ball-screw linear actuator, is connected between the carriage frame 15 and the bed 12 of the trailer. The actuator 40 has a DC motor 42 that is electrically powered from the motor vehicle that tows the trailer 10, however hydraulically powered motors or a cylinder/piston assembly can be used as the actuator. A hand operated actuator, similar to those conventionally used on trailer hitches, also may be employed. In the illustrated embodiment, the motor 42 of the actuator 40 is secured to the carriage frame 15 with the actuator screw shaft 44 extending downward from the motor and having a remote end connected to a bracket 46 on the rear side of the under frame 16. As will be described, the actuator 40 produces bidirectional, vertical motion between the trailer bed 12 and the carriage frame 15. Depending upon the polarity of the electricity applied to the motor 42, the screw shaft 44 is retracted into or extended from the motor, thereby producing up or down motion.

With reference to FIGS. 1, 2 and 4, the front side of the bed 12 has another pair of vertically extending front posts 50 that are spaced apart by an amount that is centered on the mid-point of that side. The front posts 50 form a second frame 51. Suitable cross members may be attached between the two vertical post 50 additional structural support. Four L-shaped guides 52 are located on the sides of the front posts 50, in the same manner as guides 24 are attached to the rear posts 22. The coupling 14 has frame 53 formed by a pair of vertical legs 54 and a pair of cross members 56 and 58 welded between upper and lower ends of the coupling legs 54. The vertical legs 54 are received within the L-shaped guides 52 which direct the movement of those legs vertically along the front posts 50. A coupling bracket 60 projects forward from the coupling 14.

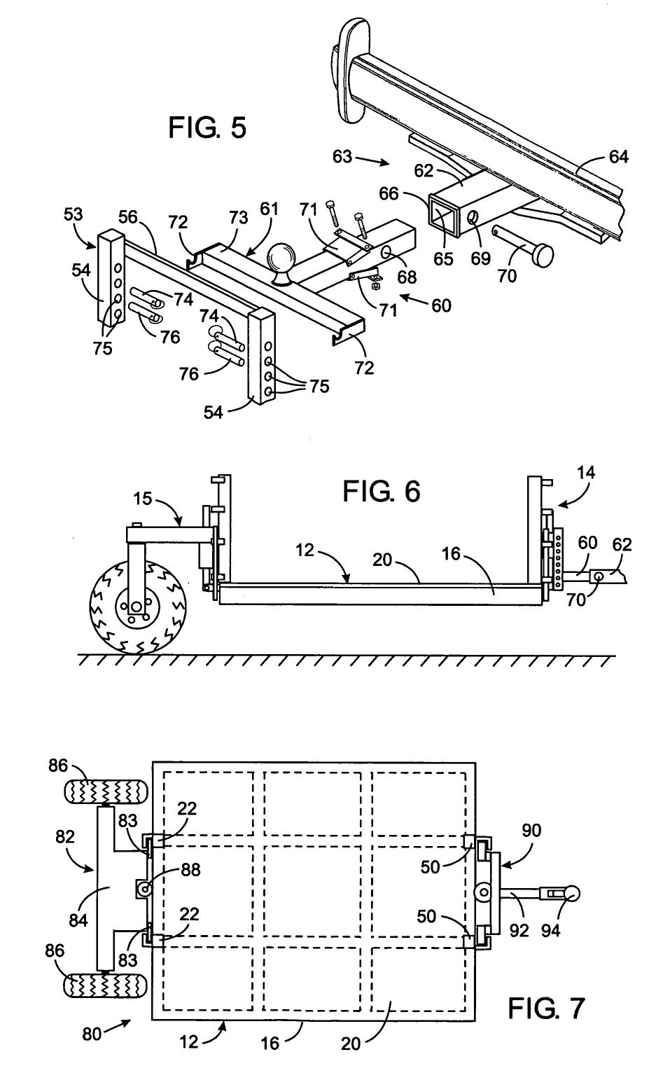

With specific reference to FIG. 5, the coupling bracket 60 preferably is a T-shaped bar 61 with a square cross section that is sized to fit within the square receptacle 62 of a conventional motor vehicle hitch 63. This type of receptacle 62 commonly receives a member with a ball that provides an articulated trailer coupling. Although a ball is not used with the present single wheeled trailer 10, one may be provided on the coupling bracket 60 to accommodate conventional trailers as well as the novel traveler 10. The hitch 63 is attached to the bumper 64 and the undercarriage of a motor vehicle. The receptacle 62 has a square opening 65 within which the forward end of the trailer coupling bracket 60 fits and a flange 66 extends around the opening. A hitch pin 70 is slid into aligned apertures 68 and 69 that extend horizontally through both the receptacle 62 and the coupling bracket 60 thereby securing the trailer to the motor vehicle hitch 63. A pair of clamps 71 are pivotally attached above and below the bar 61. When the coupling bracket 60 is slid into the hitch receptacle 62, the clamps 71 are bolted together which grips the flange 66 on the end of the hitch 63 between the clamps further fastening the coupling bracket 60 to the vehicle.

Hook plates 72 are welded to the ends of a cross member 73 of the coupling bar 61. The opening of each hook plate 72 receives an upper pin 74 that is inserted into one of a series of vertically spaced apertures 75 in one of the vertical legs 54 of the trailer coupling 14. Upon that engagement, a lower pin 76 is inserted in another one of the apertures 75 beneath the hook plate 72. The spacing between adjacent apertures 75 is such that with the pins 74 and 76 in place, the hook plates 72, and thus the coupling bracket 60, can not the removed from the vertical legs 54. This secures the components of the trailer coupling 14 together in a manner that allows the height of the coupling bracket 60 to be adjusted to accommodate variation in height of the hitch receptacle 62 on different vehicles.

The adjustment is made by inserting a detached coupling bracket 60 into the hitch receptacle 62 on a motor vehicle. The vehicle is moved backward until the hook plates 72 are between the vertical legs 54 of the trailer coupling 14. The upper pins 74 then are inserted into the vertical leg apertures 75 that are immediately above the hook plates 72 and the vertical legs 54 are lowered, as will be described, until those pins rest in the openings in the hook plates. The lower pins 76 are then inserted into the leg apertures 75 that are immediately below the hook plates 72.

Referring again to FIGS. 1, 2 and 4, a second actuator 77 produces vertical motion between the coupling 14 and the trailer bed 12. This second actuator 77 preferably is identical to the first actuator 40. For example, the second actuator 77 includes an electrically powered motor 78 attached to the coupling 14 with a drive screw 79 extending downward there from with a remote end attached to the under frame 16 of the bed 12. Activation of the second actuator 77 extends or retracts the screw shaft from the motor 78, thereby raising or lowering the coupling 14 along the bed posts 50. The coupling 14 and in particular the coupling bracket 60 are illustrated raised upward along the front posts 50 of the bed 12.

FIG. 2 illustrates the trailer 10 with the bed 12 resting on the ground so that a load can be easily loaded or unloaded from the bed. This position facilitates loads with wheels, such as garden tractors and snowmobiles, to be easily driven onto and off of the platform 21. In this position, activation of only the second actuator 77 raises and lowers the vertical legs 54 to a height at which they can be connected to the coupling bracket 60 on a motor vehicle. After the trailer 10 has been connected to the motor vehicle hitch, both of the actuators 40 and 77 are operated simultaneously to raise the bed 12 off the ground to a height at which the trailer can be pulled over a road as illustrated in FIG. 6.

The present mechanism for raising an lowering the bed of a trailer also can be used on two-wheeled trailer, such as trailer 80 in FIG. 7. The bed 12 of the trailer 80 is the same as described previously for the single-wheeled trailer 10. A carriage frame 82 is slideably coupled to the rear posts 22 of the bed 12 in the same manner as well. However, a T-shaped wheel mount 84 is welded to the legs 83 of the carriage frame 82. An axel extends across the wheel mount 84 and a wheel 86 is attached to each end of that axel. Operating an actuator 88 raises and lowers the trailer bed 12 with respect to the carriage frame 82.

The coupling 90 at the front of the bed 12 is able to slide vertically along the front posts 50 when driven by another actuator 92. The coupling 90 has a bracket 94 with a conventional socket 96 that is adapted to receive the ball of a standard trailer hitch. Because the trailer 80 in FIG. 7 has two wheels 86, a conventional pivoting, or articulated, coupling can be used to attach the trailer to a motor vehicle.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A utility trailer for towing on a road by a motor vehicle, that utility trailer comprising:
a platform which supports a load carried by the utility trailer while traveling on the road;
a coupling moveably connected to the platform for mating with a hitch on the motor vehicle;
a carriage frame moveably connected to the platform;
an actuator assembly operably engaging the platform to produce raise and lower the platform with respect to the road; and
a wheel attached to the carriage frame to support the utility trailer on the road.

2. The utility trailer as recited in claim 1 wherein the actuator assembly comprises a first actuator connected to the platform and the carriage frame to produce vertical motion there between; and a second actuator connected to the platform and the coupling to produce vertical motion there between.

3. The utility trailer as recited in claim 2 wherein the first actuator and the second actuator are operated by either electricity or hydraulic fluid.

4. The utility trailer as recited in claim 2 wherein the first actuator and the second actuator are linear actuators.

5. The utility trailer as recited in claim 2 wherein the first actuator and the second actuator are ball screw linear actuators.

6. The utility trailer as recited in claim 1 further comprising a first frame attached to the platform and to which the carriage frame is slideably coupled.

7. The utility trailer as recited in claim 1 further comprising a second frame attached to the platform and to which the coupling is slideably coupled.

8. The utility trailer as recited in claim 1 wherein the coupling comprises a coupling bracket that provides a non-articulated connection to a hitch on the motor vehicle.

9. The utility trailer as recited in claim 1 wherein the coupling comprises:
a frame that is moveably connected to the platform and has a plurality of apertures spaced vertically therein,
at least one pin received in a selected one of the plurality of apertures in the frame; and
a coupling bracket having a hook that receives the pin to attach the coupling to the frame and having a portion for mating with a hitch on the motor vehicle.

10. The utility trailer as recited in claim 1 wherein only a single wheel is attached to the carriage frame.

11. A utility trailer for towing on a road by a motor vehicle, that utility trailer comprising:
a bed on which a load on placed while the utility trailer travels on the road;
a carriage frame moveably connected to the bed;
a first actuator connected to the bed and the carriage frame to produce vertical motion there between;
at least one wheel attached to the carriage frame to support the utility trailer on a road;
a coupling moveably connected to the bed for mating with a hitch on the motor vehicle; and
a second actuator connected to the bed and the coupling to produce vertical motion there between.

12. The utility trailer as recited in claim 11 wherein the bed comprises:
a platform with first and second sides;
a first frame attached to the platform adjacent the first side and to which the carriage frame is movably coupled; and
a second frame attached to the platform adjacent the second side and to which the coupling is movably attached.

13. The utility trailer as recited in claim 11 wherein the first actuator and the second actuator are operated by either electricity or hydraulic fluid.

14. The utility trailer as recited in claim 10 wherein the wherein the first actuator and the second actuator are linear actuators.

15. The utility trailer as recited in claim 10 wherein the coupling comprises a bracket that provides a non-articulated connection to a hitch on the motor vehicle.

16. The utility trailer as recited in claim 10 wherein the coupling comprises:
a frame that is moveably connected to the platform and has a first plurality of apertures spaced vertically therein and a second plurality of apertures spaced vertically therein;
a first pin received in a selected one of the first plurality of apertures in the frame;
a second pin received in a selected one of the second plurality of apertures; and
a coupling bracket having a first hook that receives the first pin and a second hook that receives the second pin to thereby attach the coupling bracket to the frame, and having a portion for mating with a hitch on the motor vehicle.

17. The utility trailer as recited in claim 11 wherein only a single wheel is attached to the carriage frame.

18. A utility trailer for towing on a road by a motor vehicle, that utility trailer comprising:
a bed on which a load on placed while the utility trailer travels on the road, the bed having a platform with first and second sides, a first frame attached to the platform adjacent the first side, and a second frame attached to the platform adjacent the second side;
a carriage frame slideably connected to the first frame;
a first linear actuator connected to the bed and the carriage frame to produce vertical motion there between;
only one wheel supporting the utility trailer on a road and being attached to the carriage frame;
a coupling slideably connected to the second frame for mating with a hitch on the motor vehicle; and
a second linear actuator connected to the bed and the coupling to produce vertical motion there between.

19. The utility trailer as recited in claim 18 wherein the first actuator and the second actuator are operated by either electricity or hydraulic fluid.

20. The utility trailer as recited in claim 18 wherein the coupling comprises a bracket that provides a non-articulated connection to a hitch on the motor vehicle.

21. The utility trailer as recited in claim 18 wherein the coupling comprises:
a frame that is moveably connected to the platform and has a plurality of apertures spaced vertically therein,
at least one pin received in a selected one of the plurality of apertures in the frame; and
a coupling bracket having a hook that receives the pin to attach the coupling to the frame and having a portion for mating with a hitch on the motor vehicle.
